(19) United States
(12) Patent Application Publication
(10) Pub. No.: US 2024/0170770 A1
(43) Pub. Date: May 23, 2024

(54) LITHIUM-AIR BATTERY-BASED POWER SUPPLY APPARATUS AND CONTROL METHOD THEREOF

(71) Applicants: HYUNDAI MOTOR COMPANY, Seoul (KR); KIA CORPORATION, Seoul (KR); SEOUL NATIONAL UNIVERSITY R&DB FOUNDATION, Seoul (KR)

(72) Inventors: Hoimin Kwon, Suwon-si (KR); Youngsuk Cho, Sejong-si (KR); Suhyun Kim, Seoul (KR); Kyounghan Ryu, Yongin-si (KR); Yeongho Lee, Seoul (KR); Jinyoung Park, Incheon (KR); Yooil Lee, Anyang-si (KR); Minsoo Kim, Seoul (KR)

(73) Assignees: HYUNDAI MOTOR COMPANY, Seoul (KR); KIA CORPORATION, Seoul (KR); SEOUL NATIONAL UNIVERSITY R&DB FOUNDATION, Seoul (KR)

(21) Appl. No.: 18/206,988

(22) Filed: Jun. 7, 2023

(30) Foreign Application Priority Data
Nov. 22, 2022 (KR) 10-2022-0157204

(51) Int. Cl. H01M 12/08; H01M 8/04082; H01M 8/04119; H01M 8/04276; H01M 8/04492

(52) U.S. Cl. CPC H01M 12/08; H01M 8/04119; H01M 8/04201; H01M 8/04276; H01M 8/04492

(57) ABSTRACT

A power supply apparatus includes: an air supply part provided to supply air; a dehumidification part configured to remove moisture in the air supplied from the air supply part; an oxygen concentration part including a first oxygen concentration member, a second oxygen concentration member, and a vacuum pump configured to separate and concentrate oxygen from the air; a battery part including a lithium-air battery and configured to be supplied with the concentrated oxygen from the oxygen concentration part; and a controller. The controller is configured to, in response to discharging the lithium-air battery, generate the concentrated oxygen to be supplied to the lithium-air battery by driving one of the first oxygen concentration member or the second oxygen concentration member and regenerate the other of the first oxygen concentration member or the second oxygen concentration member by driving the vacuum pump while the concentrated oxygen is generated.

### CROSS-REFERENCE TO RELATED APPLICATION

This application is based on and claims priority under 35 U.S.C. § 119 to Korean Patent Application No. 10-2022-0157204, filed on Nov. 22, 2022 in the Korean Intellectual Property Office, the disclosure of which is incorporated herein by reference.

### TECHNICAL FIELD

The disclosure relates to a power supply apparatus, and more particularly, to a lithium-air battery-based power supply apparatus and a control method thereof.

### BACKGROUND

The statements in this section merely provide background information related to the present disclosure and do not necessarily constitute prior art. As may be seen from the United Nations Framework Convention on Climate Change and the EU Taxonomy, a global transition to green energy is rapidly in progress. Also, demand for eco mobility devices using electric energy is continuously increasing due to strengthening of regulations of fuel efficiency and emission.

For the development of the eco mobility industry using electric energy, commercialization of high-performance batteries with high energy density is crucial. A lithium-air battery has considerably higher energy density than a lithium-ion battery. Lithium-air batteries are at the center of attention as next-generation batteries due to high energy density.

In order to apply lithium-air batteries to eco mobility devices, the stability and lifespan of lithium-air batteries are required to be increased, and a humidity control system (adsorption system) and an oxygen concentration enrichment system are required to be optimized for lithium-air batteries.

### SUMMARY

An aspect of the present disclosure provides a lithium-air battery-based power supply apparatus suitable for small mobility devices by miniaturizing the lithium-air battery-based power supply apparatus and increasing the stability and lifespan of the lithium-air battery-based power supply apparatus. Another aspect of the present disclosure also provides a control method thereof.

Additional aspects of the present disclosure, in part, are set forth in the following description. Additional aspects of the present disclosure, in part, should be apparent from the description or may be learned by practice of the disclosure.

According to an aspect of the present disclosure, a power supply apparatus includes an air supply part provided to supply air and a dehumidification part configured to remove moisture in the air supplied from the air supply part. The power supply apparatus also includes an oxygen concentration part including a first oxygen concentration member, a second oxygen concentration member, and a vacuum pump configured to separate and concentrate oxygen from the air from which moisture is removed by the dehumidification part. The power supply apparatus also includes a battery part including a lithium-air battery and configured to be supplied with the concentrated oxygen from the oxygen concentration part. The power supply apparatus also includes a controller configured to, in response to discharging the lithium-air battery, generate the concentrated oxygen to be supplied to the lithium-air battery by driving one of the first oxygen concentration member or the second oxygen concentration member. The controller is also configured to regenerate the other one of the first oxygen concentration member or the second oxygen concentration member by driving the vacuum pump while the concentrated oxygen is generated.

The dehumidification part includes: a first dehumidifying member; a second dehumidifying member; and a heating member configured to heat the first dehumidifying member and the second dehumidifying member. In response to charging the lithium-air battery, the first dehumidifying member and the second dehumidifying member are heated by using the heating member. Air passing through the first dehumidifying member and the second dehumidifying member is discharged to an outside through the vacuum pump.

The air supply part includes an air pump configured to draw outside air and supply to a downstream of the air pump. A discharge port of the air pump is branched into two air flow paths. One of the two air flow paths is connected to the first dehumidifying member. The other one of the two air flow paths is connected to the second dehumidifying member. A first valve is provided in the air flow path connecting the discharge port of the air pump and the first dehumidifying member. A second valve is provided in the air flow path connecting the discharge port of the air pump and the second dehumidifying member.

A third valve is provided in an air flow path between a discharge port of the first dehumidifying member and the first oxygen concentration member. A fourth valve is provided in an air flow path between a discharge port of the second dehumidifying member and the second oxygen concentration member. A fifth valve is provided in an air flow path between an inlet port of the vacuum pump and an inlet port of the first oxygen concentration member which is a downstream of the third valve. A sixth valve is provided in an air flow path between the inlet port of the vacuum pump and an inlet port of the second oxygen concentration member, which is a downstream of the fourth valve. A seventh valve is provided in an air flow path between an inlet port of the lithium-air battery and a discharge port of the first oxygen concentration member. An eighth valve is provided in an air flow path between the inlet port of the lithium-air battery and a discharge port of the second oxygen concentration member.

The vacuum pump is connected between an inlet port of the first oxygen concentration member and an inlet port of the second oxygen concentration member.

The power supply apparatus further includes a ninth valve provided among a downstream of the first oxygen concentration member, a downstream of the second oxygen concentration member, and an inlet port of the lithium-air battery.

A flow path of the ninth valve is configured to be controlled so that air, discharged from the first oxygen concentration member and flowing through the seventh valve, flows into an inlet port of the lithium-air battery. The flow path of the ninth valve is also configured to be controlled so that air, discharged from the second oxygen concentration member and flowing through the eighth valve, flows into the inlet port of the lithium-air battery. The flow path of the ninth valve is also configured to be controlled so that air flowed from the outside flows into the first oxygen concentration member and the second oxygen concentration member.

In response to charging the lithium-air battery, the controller is configured to control the first oxygen concentration member and the second oxygen concentration member to be regenerated by circulating outside air in the oxygen concentration part through a switch of the flow path of the ninth valve and driving of the vacuum pump.

To regenerate the first oxygen concentration member and the second oxygen concentration member, the controller is configured to control the flow path of the ninth valve to be switched to supply air to the first oxygen concentration member and the second oxygen concentration member by introducing the outside air. The controller is also configured to control the vacuum pump to be driven to discharge air passing through the first oxygen concentration member and the second oxygen concentration member outside.

According to an aspect of the disclosure, a control method of a power supply apparatus is provided. The power supply apparatus includes an air supply part provided to supply air and a dehumidification part configured to remove moisture in the air supplied from the air supply part. The power supply apparatus also includes an oxygen concentration part including a first oxygen concentration member, a second oxygen concentration member, and a vacuum pump configured to separate and concentrate oxygen from the air from which moisture is removed by the dehumidification part. The power supply apparatus also includes a battery part including a lithium-air battery and configured to be supplied with the concentrated oxygen from the oxygen concentration part. The control method includes, in response to discharging the lithium-air battery, generating the concentrated oxygen to be supplied to the lithium-air battery by driving one of the first oxygen concentration member or the second oxygen concentration member. The control method also includes regenerating the other one of the first oxygen concentration member or the second oxygen concentration member by driving the vacuum pump while the concentrated oxygen is generated.

The dehumidification part includes: a first dehumidifying member; a second dehumidifying member; and a heating member configured to heat the first dehumidifying member and the second dehumidifying member. In response to charging the lithium-air battery, the first dehumidifying member and the second dehumidifying member are heated by using the heating member. Air passing through the first dehumidifying member and the second dehumidifying member is discharged to an outside through the vacuum pump.

The air supply part includes an air pump configured to draw outside air and supply to a downstream of the air pump. A discharge port of the air pump is branched into two air flow paths. One of the two air flow paths is connected to the first dehumidifying member. The other one of the two air flow paths is connected to the second dehumidifying member. A first valve is provided in the air flow path connecting the discharge port of the air pump and the first dehumidifying member. A second valve is provided in the air flow path connecting the discharge port of the air pump and the second dehumidifying member.

A third valve is provided in an air flow path between a discharge port of the first dehumidifying member and the first oxygen concentration member. A fourth valve is provided in an air flow path between a discharge port of the second dehumidifying member and the second oxygen concentration member. A fifth valve is provided in an air flow path between an inlet port of the vacuum pump and an inlet port of the first oxygen concentration member, which is a downstream of the third valve. A sixth valve is provided in an air flow path between the inlet port of the vacuum pump and an inlet port of the second oxygen concentration member which is a downstream of the fourth valve. A seventh valve is provided in an air flow path between an inlet port of the lithium-air battery and a discharge port of the first oxygen concentration member. An eighth valve is provided in an air flow path between the inlet port of the lithium-air battery and a discharge port of the second oxygen concentration member.

The vacuum pump is connected between an inlet port of the first oxygen concentration member and an inlet port of the second oxygen concentration member.

The power supply apparatus further includes a ninth valve provided among a downstream of the first oxygen concentration member, a downstream of the second oxygen concentration member, and an inlet port of the lithium-air battery.

A flow path of the ninth valve is configured to be controlled so that air, discharged from the first oxygen concentration member and flowing through the seventh valve, flows into an inlet port of the lithium-air battery. The flow path of the ninth valve is also configured to be controlled so that air, discharged from the second oxygen concentration member and flowing through the eighth valve, flows into the inlet port of the lithium-air battery. The flow path of the ninth valve is also configured to be controlled so that air flowed from the outside flows into the first oxygen concentration member and the second oxygen concentration member.

In response to charging the lithium-air battery, the first oxygen concentration member and the second oxygen concentration member are regenerated by circulating outside air in the oxygen concentration part through a switch of the flow path of the ninth valve and driving of the vacuum pump.

To regenerate the first oxygen concentration member and the second oxygen concentration member, the flow path of the ninth valve is switched to supply air to the first oxygen concentration member and the second oxygen concentration member by introducing the outside air. The vacuum pump is driven to discharge air passing through the first oxygen concentration member and the second oxygen concentration member outside.

Another aspect of the disclosure provides a control method of a power supply apparatus. The power supply apparatus includes an air supply part provided to supply air and a dehumidification part configured to remove moisture in the air supplied from the air supply part. The power supply apparatus also includes an oxygen concentration part including a first oxygen concentration member, a second oxygen concentration member, and a vacuum pump configured to separate and concentrate oxygen from the air from which moisture is removed by the dehumidification part. The power supply apparatus also includes a battery part including a lithium-air battery and configured to be supplied with the concentrated oxygen from the oxygen concentration part. The power supply apparatus also includes a four-way valve provided among a downstream of the first oxygen concentration member, a downstream of the second oxygen concentration member, and an inlet port of the lithium-air battery. The control method includes, in response to discharging the lithium-air battery, generating the concentrated oxygen to be supplied to the lithium-air battery by driving one of the first oxygen concentration member or the second oxygen concentration member. The control method also includes regenerating the other one of the first oxygen concentration member or the second oxygen concentration member by driving the vacuum pump while the concentrated oxygen is generated. The control method also includes, in response to charging the lithium-air battery, heating the dehumidification part by using a heating member provided in the dehumidification part, and discharging air passing through the dehumidification part to an outside through the vacuum pump. The control method also includes, in response to charging the lithium-air battery, regenerating the oxygen concentration part by circulating outside air in the oxygen concentration part through a switch of a flow path of the four-way valve and driving of the vacuum pump.

### BRIEF DESCRIPTION OF THE DRAWINGS

These and/or other aspects of the disclosure should become apparent and more readily appreciated from the following description of the embodiments, taken in conjunction with the accompanying drawings in which:

FIG. 1 is a diagram illustrating a lithium-air battery-based power supply apparatus according to an embodiment;

FIG. 2 is a diagram illustrating a detailed configuration of the lithium-air battery-based power supply apparatus shown in FIG. 1;

FIG. 3 is a flowchart illustrating a control method of a lithium-air battery-based power supply apparatus according to an embodiment;

FIG. 4 is a diagram illustrating operations for <discharging: dehumidification> of a lithium-air battery-based power supply apparatus according to an embodiment;

FIG. 5 is a diagram illustrating operations for <discharging: oxygen concentration> of a lithium-air battery-based power supply apparatus according to an embodiment;

FIG. 6 is a diagram illustrating operations for <use of a first oxygen concentration column> of a lithium-air battery-based power supply apparatus according to an embodiment;

FIG. 7 is a diagram illustrating operations for <regeneration of a first oxygen concentration column and use of a second oxygen concentration column> of a lithium-air battery-based power supply apparatus according to an embodiment;

FIG. 8 is a diagram illustrating operations of <charging: regeneration of an adsorption dehumidification column> performed while charging a lithium-air battery in a lithium-air battery-based power supply apparatus according to an embodiment; and

FIG. 9 is a diagram illustrating operations of <charging: regeneration of an oxygen concentration column> performed while charging a lithium-air battery in a lithium-air battery-based power supply apparatus according to an embodiment.

### DETAILED DESCRIPTION

Like reference numerals throughout the specification denote like elements. Also, this specification does not describe all the elements according to embodiments of the present disclosure, and descriptions well-known in the art to which the disclosure pertains or overlapped portions have been omitted. The terms such as “˜part”, “˜module”, and the like may refer to at least one process processed by at least one hardware or software. According to embodiments, a plurality of “˜parts”, “˜modules”, or the like may be embodied as a single element, or a single of a “˜part”, “˜module”, or the like may include a plurality of elements.

It should be understood that, when an element is referred to as being “connected” to another element, the element can be directly or indirectly connected to the other element. The indirect connection includes “connection” via a wireless communication network.

It should be understood that the term “include”, when used in the present disclosure, specifies the presence of stated features, integers, steps, operations, elements, and/or components but does not preclude the presence or addition of at least one other features, integers, steps, operations, elements, components, and/or groups thereof.

It should be understood that, when it is stated in the present disclosure that a member is located “on” another member, not only a member may be in contact with another member, but also still another member may be present between the two members.

It should be understood that, although the terms first, second, etc. may be used herein to describe various elements, these elements should not be limited by these terms.

It should be understood that the singular forms are intended to include the plural forms as well, unless the context clearly dictates otherwise.

Reference numerals used for method steps are just used for convenience of explanation but are not intended to limit an order of the steps. Thus, unless the context clearly dictates otherwise, the written order may be practiced otherwise. When a component, device, element, or the like of the present disclosure is described as having a purpose or performing an operation, function, or the like, the component, device, element, or the like should be considered herein as being “configured to” meet that purpose or to perform that operation or function. Each of the component, device, element, and the like may separately embody or be included with a processor and a memory, such as a non-transitory computer readable media, as part of the apparatus.

Hereinafter, an operation principle and embodiments of the disclosure are described in detail with reference to the accompanying drawings.

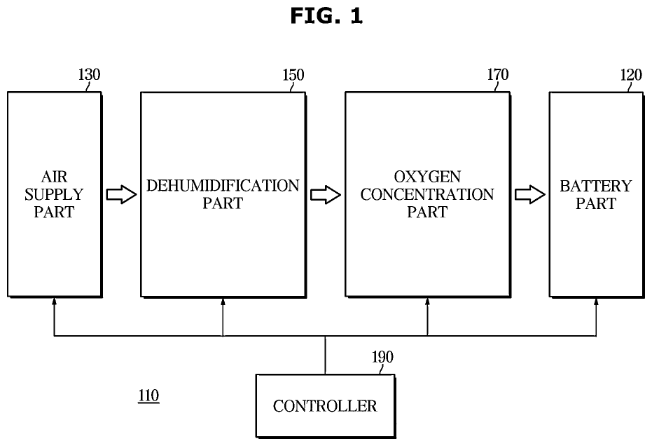

FIG. 1 is a diagram illustrating a lithium-air battery-based power supply apparatus according to an embodiment. A lithium-air battery-based power supply apparatus 110 shown in FIG. 1 is for supplying power to a relatively small eco mobility device based on a lithium-air battery. As shown in FIG. 1, the lithium-air battery-based power supply apparatus 110 of an eco mobility device according to an embodiment includes a battery part 120, an air supply part 130, a dehumidification part 150, an oxygen concentration part 170, and a controller 190.

The air supply part 130 is provided to draw outside air and supply to the dehumidification part 150 located at a downstream thereof. The dehumidification part 150 is provided to adsorb moisture (humidity) in the air supplied from the air supply part 130. The oxygen concentration part 170 is provided to extract and concentrate oxygen from air from which moisture has been removed to a predetermined level. The oxygen concentrated by the oxygen concentration part 170 is supplied to the battery part 120. The controller 190 controls overall operations of the battery part 120, the air supply part 130, the dehumidification part 150, and the oxygen concentration part 170 constituting the lithium-air battery-based power supply apparatus 110.

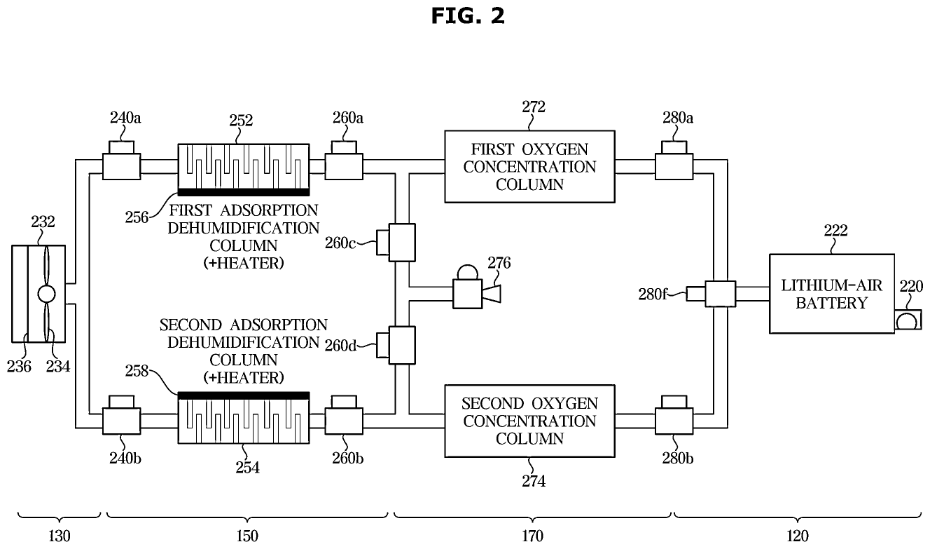

FIG. 2 is a diagram illustrating a detailed configuration of the lithium-air battery-based power supply apparatus shown in FIG. 1.

The air supply part 130 includes an air pump 232 drawing outside air and supplying to the dehumidification part 150 located at a downstream thereof. The air pump 232 supplies air of 4 bar or less to the dehumidification part 150 as a compression (pressurization) means. In existing lithium-air battery-based power supply apparatuses, a large and expensive compressor has been used as a compression (pressurization) means for supplying high-concentration oxygen. According to an embodiment, however, compression (pressurization) is performed using a small and inexpensive air pump 232 instead of the existing compressor. By using the air pump 232 instead of the compressor, the amount of power consumed by the air supply part 130 may be significantly reduced. Also, due to the small size of the air pump 232 in comparison to the compressor, and the like, a size of the lithium-air battery-based power supply apparatus may be reduced. The air pump 232 may include a fan 234 and a dust filter 236. The fan 234 is provided to draw outside air into the air pump 232. The dust filter 236 is provided to filter dust from air flowing into the air pump 232.

The dehumidification part 150 is provided to perform dehumidification by adsorbing moisture in the air supplied from the air pump 232 of the air supply part 130.

By removing a significant amount of moisture in the air through the dehumidification part 150, an oxygen concentration efficiency of the oxygen concentration part 170 located downstream thereof may be greatly increased. To this end, the dehumidification part 150 includes a first adsorption dehumidification column (first dehumidifying member) 252 and a second adsorption dehumidification column (second dehumidifying member) 254.

Each of the first adsorption dehumidification column 252 and the second adsorption dehumidification column 254 adsorbs moisture in the air by using a 5A zeolite pellet or a MoF adsorbent. The saturated moisture adsorption amount of the 5A zeolite pellet constituting each of the first adsorption dehumidification column 252 and the second adsorption dehumidification column 254 is approximately 20 to 30 wt %. According to an embodiment, when regeneration accompanied by heating is performed for approximately 50 minutes, a saturated moisture rate of the first adsorption dehumidification column 252 and the second adsorption dehumidification column 254 may be reduced from 30 wt % to 10 wt % or less. According to an embodiment, when regeneration accompanied by heating of approximately 100° C. is performed for approximately 120 minutes, a saturated moisture rate of the first adsorption dehumidification column 252 and the second adsorption dehumidification column 254 may be reduced to 5 wt % or less.

As the number of regenerations of the first adsorption dehumidification column 252 and the second adsorption dehumidification column 254 increases, an adsorption performance may decrease. Accordingly, in a regeneration process of the dehumidification part 150 of the lithium-air battery-based power supply apparatus 110 according to an embodiment, when charging a lithium-air battery 222, the first adsorption dehumidification column 252 and the second adsorption dehumidification column 254 are heated by heaters 256 and 258. To this end, the heaters 256 and 258 including a line heater or a heating tape are provided in the first adsorption dehumidification column 252 and the second adsorption dehumidification column 254, respectively.

In an area with high humidity, use of 3A zeolite instead of 5A zeolite may increase the saturated moisture adsorption amount to approximately 35%.

A discharge port of the air pump 232 may be branched into two air flow paths, which are connected to the first adsorption dehumidification column 252 and the second adsorption dehumidification column 254, respectively. In other words, one of the two air flow paths branched from the discharge port of the air pump 232 may be connected to the first adsorption dehumidification column 252, and the other one of the two air flow paths may be connected to the second adsorption dehumidification column 254. A solenoid valve 240a is provided in an air flow path connecting the discharge port of the air pump 232 and the first adsorption dehumidification column 252. A flow of air from the air pump 232 to the first adsorption dehumidification column 252 may be controlled according to opening and closing of the solenoid valve (first valve) 240a. A solenoid valve 240b is provided in an air flow path connecting the discharge port of the air pump 232 and the second adsorption dehumidification column 254. A flow of air from the air pump 232 to the second adsorption dehumidification column 254 may be controlled according to opening and closing of the solenoid valve (second valve) 240b.

The oxygen concentration part 170 includes a first oxygen concentration column (first oxygen concentration member) 272, a second oxygen concentration column (second oxygen concentration member) 274, and a vacuum pump 276. An inlet port of the first oxygen concentration column 272, an inlet port of the second oxygen concentration column 274, an inlet port of the vacuum pump 276, a discharge port of the first adsorption dehumidification column 252, and a discharge port of the second adsorption dehumidification column 254 are connected to each other through a plurality of air flow paths.

As an example of a method of separating (extracting) oxygen from air by the oxygen concentration part 170, a pressure swing adsorption (PSA) method is described based on a principle that nitrogen, which is a strongly adsorbed component, is adsorbed to an adsorbent, and oxygen, which is a relatively weakly adsorbed component, passes through the adsorbent. Meanwhile, compressed air flowing in the oxygen concentration part 170 passes through the first oxygen concentration column 272 and the second oxygen concentration column 274, which are filled with zeolite. When the first oxygen concentration column 272 and the second oxygen concentration column 274 are decompressed, desorption, which is opposite of adsorption, occurs. By the desorption, nitrogen adsorbed by the first oxygen concentration column 272 and the second oxygen concentration column 274 is discharged from the first oxygen concentration column 272 and the second oxygen concentration column 274. Thus, the first oxygen concentration column 272 and the second oxygen concentration column 274 are regenerated. As described above, according to an embodiment, the air pump 232 of the air supply part 130 performs compression (pressurization) by drawing outside air. By contrast, the vacuum pump 276 of the oxygen concentration part 170 is a decompression means for reducing pressure of the dehumidification part 150 or the oxygen concentration part 170. Through the pressure reduction, desorption (regeneration) in the dehumidification part 150 or the oxygen concentration part 170 may be performed.

A solenoid valve (third valve) 260a is provided in an air flow path between the first oxygen concentration column 272 and a discharge port of the first adsorption dehumidification column 252. A flow of air to the first oxygen concentration column 272 from the first adsorption dehumidification column 252 may be controlled according to opening and closing of the solenoid valve (third valve) 260a.

A solenoid valve (fourth valve) 260b is provided in an air flow path between the second oxygen concentration column 274 and a discharge port of the second adsorption dehumidification column 254. A flow of air to the second oxygen concentration column 274 from the second adsorption dehumidification column 254 may be controlled according to opening and closing of the solenoid valve (fourth valve) 260b.

A solenoid valve (fifth valve) 260c is provided in an air flow path between an inlet port of the first oxygen concentration column 272, which is a downstream of the solenoid valve 260a, and an inlet port of the vacuum pump 276. A flow of air from the inlet port of the first oxygen concentration column 272, which is the downstream of the solenoid valve 260a, to the inlet port of the vacuum pump 276 may be controlled according to opening and closing of the solenoid valve (fifth valve) 260c.

A solenoid valve (sixth valve) 260d is provided in an air flow path between an inlet port of the second oxygen concentration column 274, which is a downstream of the solenoid valve 260b, and the inlet port of the vacuum pump 276. A flow of air from the inlet port of the second oxygen concentration column 274, which is the downstream of the solenoid valve 260b, to the inlet port of the vacuum pump 276 may be controlled according to opening and closing of the solenoid valve (sixth valve) 260d.

According to an embodiment, a regeneration speed is increased using the vacuum pump 276 in the oxygen concentration part 170. The vacuum pump 276 is connected between the inlet port of each of the first oxygen concentration column 272 and the second oxygen concentration column 274 and is provided to discharge air from each of the first oxygen concentration column 272 and the second oxygen concentration column 274 to an outside. When nitrogen is adsorbed in the second oxygen concentration column 274, an air pressure is pressurized to an atmospheric pressure or to a 4 bar level. However, during regeneration, pressure may be rapidly reduced to a vacuum state pressure by operations of the vacuum pump 276.

The discharge port of the first oxygen concentration column 272, the discharge port of the second oxygen concentration column 274, and an inlet port of the lithium-air battery 222 are connected to each other via air flow paths.

A solenoid valve (seventh valve) 280a is provided in an air flow path between the discharge port of the first oxygen concentration column 272 and the inlet port of the lithium-air battery 222. A flow of air between the discharge port of the first oxygen concentration column 272 and the inlet port of the lithium-air battery 222 may be controlled according to opening and closing of the solenoid valve (seventh valve) 280a.

A solenoid valve (eighth valve) 280b is provided in an air flow path between the discharge port of the second oxygen concentration column 274 and the inlet port of the lithium-air battery 222. A flow of air between the discharge port of the second oxygen concentration column 274 and the inlet port of the lithium-air battery 222 may be controlled according to opening and closing of the solenoid valve (eighth valve) 280b.

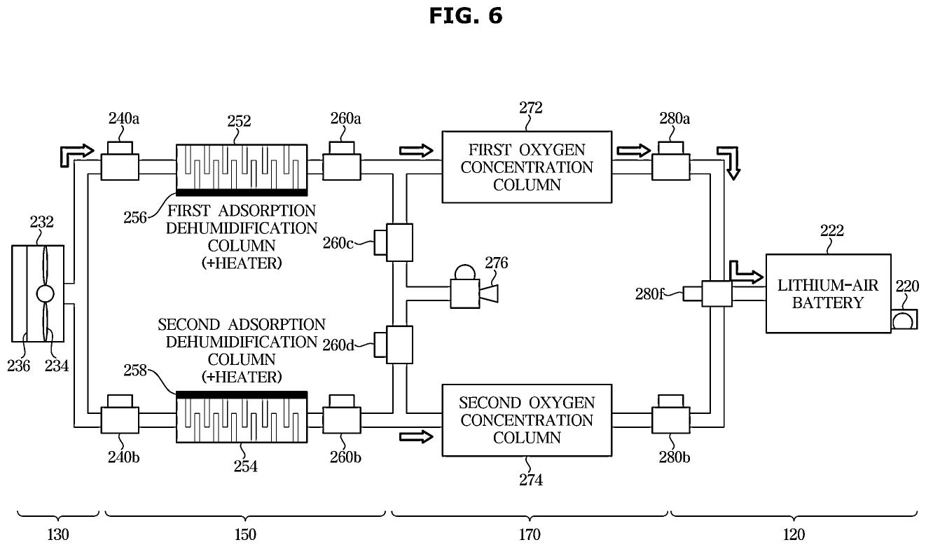

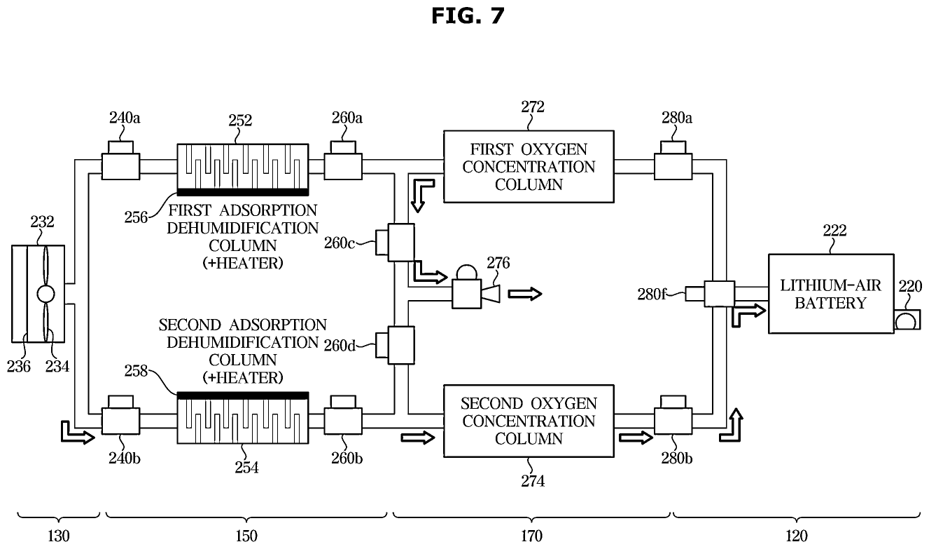

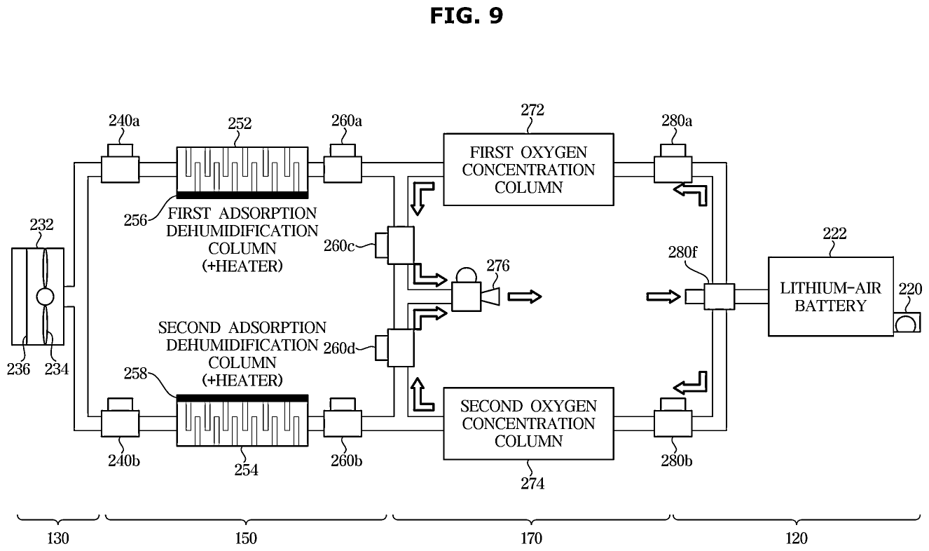

A four-way valve (ninth valve) 280f is provided between the inlet port of the lithium-air battery 222 and a downstream of each of the first oxygen concentration column 272 and the second oxygen concentration column 274. The four-way valve 280f may allow air, discharged from the first oxygen concentration column 272 and flowing through the open seventh valve 280a, to flow into the inlet port of the lithium-air battery 222 (refer to FIG. 6). Alternatively, the four-way valve 280f may allow air, discharged from the second oxygen concentration column 274 and flowing through the open eighth valve 280b, to flow into the inlet port of the lithium-air battery 222 (refer to FIG. 7). Also, the four-way valve 280f may allow air flowed from the outside to flow into the first oxygen concentration column 272 and the second oxygen concentration column 274 (refer to FIG. 9).

The battery part 120 may be in a form of a sealed box and includes the lithium-air battery 222 inside. The battery part 120 may also function as an oxygen tank. For smooth discharge of reactants, a pressure higher than atmospheric pressure by 0.3 bar to 0.5 bar is maintained at a rear end of the lithium-air battery 222. The pressure adjustment may be performed by a backpressure regulator (not shown) provided at the rear end of the lithium-air battery 222.

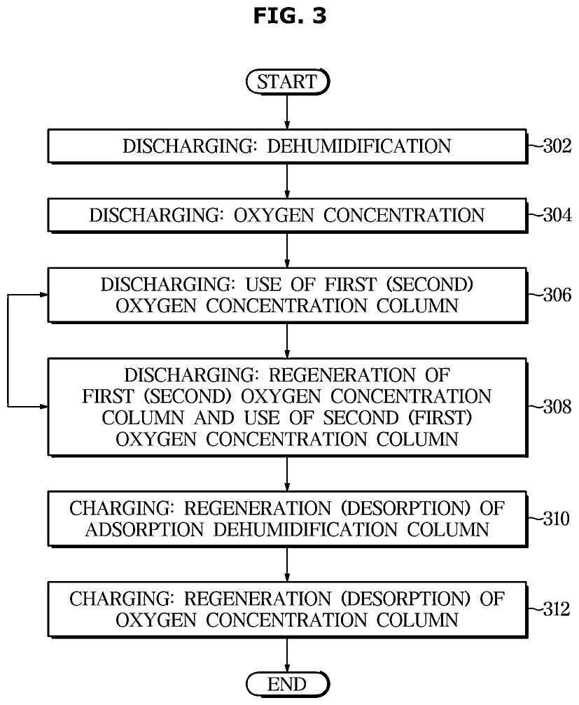

FIG. 3 is a flowchart illustrating a control method of a lithium-air battery-based power supply apparatus according to an embodiment. The control method of lithium-air battery-based power supply apparatus in FIG. 3 may be performed by the lithium-air battery-based power supply apparatus 110 shown in FIGS. 1 and 2.

As shown in FIG. 3, the control method of the lithium-air battery-based power supply apparatus 110 according to an embodiment includes dehumidification 302, oxygen concentration 304, use of the first oxygen concentration column 306, regeneration of the first oxygen concentration column and use of the second oxygen concentration column 308, regeneration of adsorption dehumidification column 310, and regeneration of the oxygen concentration column 312. Among the above operations, the dehumidification 302, the oxygen concentration 304, the use of the first oxygen concentration column 306, and the regeneration of the first oxygen concentration column and the use of the second oxygen concentration column 308 are performed when discharging the lithium-air battery 222. The regeneration of adsorption dehumidification column 310 and the regeneration of the oxygen concentration column 312 are performed when charging the lithium-air battery 222.

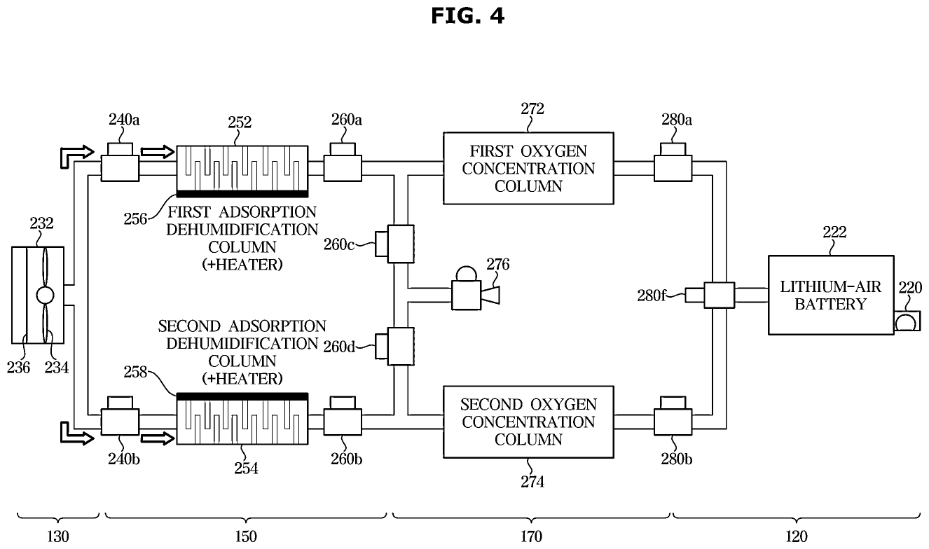

Detailed operations of the lithium-air battery-based power supply apparatus 110 in each of the above operations, i.e., the dehumidification 302, the oxygen concentration 304, the use of the first oxygen concentration column 306, the regeneration of the first oxygen concentration column and the use of the second oxygen concentration column 308, the regeneration of adsorption dehumidification column 310 and the regeneration of the oxygen concentration column 312, are described with reference to FIGS. 4-9 below.

FIGS. 4-7 illustrate operations when discharging the lithium-air battery-based power supply apparatus 110 according to an embodiment. Here, FIG. 4 is a diagram illustrating operations for <discharging: dehumidification> of the lithium-air battery-based power supply apparatus 110 according to an embodiment. In FIG. 4, arrows indicate a flow path or flow direction of gas (air or oxygen).

As shown in FIG. 4, in <discharging: dehumidification (302)> performed when discharging the lithium-air battery 222, the solenoid valves 240a and 240b are opened under control of the controller 190, and the air pump 232 of the air supply part 130 is driven. Outside air is drawn into the lithium-air battery-based power supply apparatus 110 by the driven air pump 232. The air drawn by the air pump 232 is supplied to the first adsorption dehumidification column 252 and the second adsorption dehumidification column 254 via the open solenoid valves 240a and 240b. The air supplied to the first adsorption dehumidification column 252 and the second adsorption dehumidification column 254 is dehumidified by 5A zeolite pellet or MoF adsorbent of the first adsorption dehumidification column 252 and the second adsorption dehumidification column 254, while passing through the first adsorption dehumidification column 252 and the second adsorption dehumidification column 254, respectively.

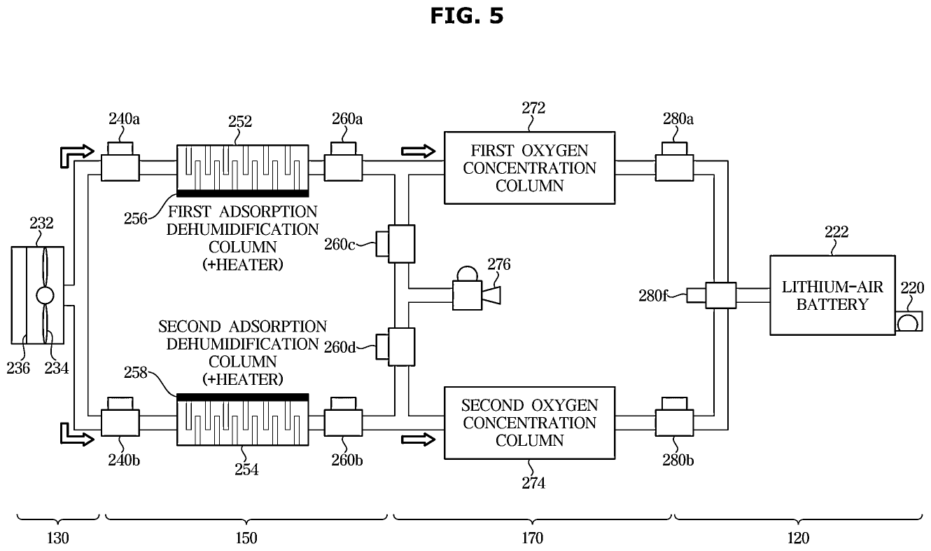

FIG. 5 is a diagram illustrating operations for <discharging: oxygen concentration> of a lithium-air battery-based power supply apparatus according to an embodiment. In FIG. 5, arrows indicate a flow path or flow direction of gas (air or oxygen).

The <discharging: oxygen concentration (304)> operations performed while discharging the lithium-air battery 222 may be performed in a state where dehumidification of the first adsorption dehumidification column 252 and the second adsorption dehumidification column 254 reaches a predetermined level. As shown in FIG. 5, the solenoid valves 260a and 260b are additionally opened under control of the controller 190 in the oxygen concentration 304. By the additional opening of the solenoid valves 260a and 260b, air where the predetermined level of dehumidification has been performed by the first adsorption dehumidification column 252 and the second adsorption dehumidification column 254 is supplied to the first oxygen concentration column 272 and the second oxygen concentration column 274. In this instance, the solenoid valves 260a and 260b, provided on inlet flow paths of the first oxygen concentration column 272 and the second oxygen concentration column 274, respectively, are opened, but the solenoid valves 280a and 280b, provided on discharge flow paths of the first oxygen concentration column 272 and the second oxygen concentration column 274, respectively, are closed. In other words, in a state where the solenoid valves 280a and 280b provided on the discharge flow paths of the first oxygen concentration column 272 and the second oxygen concentration column 274, respectively, are closed, air is supplied to the first oxygen concentration column 272 and the second oxygen concentration column 274 through the open solenoid valves 260a and 260b. Accordingly, in the first oxygen concentration column 272 and the second oxygen concentration column 274, oxygen in the air is extracted and pressurized to approximately 4 bar, and thus oxygen concentration is performed. During the oxygen concentration by the first oxygen concentration column 272 and the second oxygen concentration column 274, additional dehumidification may be performed by 13X zeolite of the first oxygen concentration column 272 and the second oxygen concentration column 274.

FIG. 6 is a diagram illustrating operations for <use of a first oxygen concentration column> of a lithium-air battery-based power supply apparatus according to an embodiment. In FIG. 6, arrows indicate a flow path or flow direction of gas (air or oxygen).

The <discharging: use of the first oxygen concentration column (306)> operations performed while discharging the lithium-air battery 222 may be performed in a state where oxygen concentration of the first oxygen concentration column 272 and the second oxygen concentration column 274 reaches a predetermined level. As shown in FIG. 6, the solenoid valve 280a is additionally opened under control of the controller 190 in the <discharging: use of the first oxygen concentration column (306)>. The solenoid valve 280b is maintained in a closed state. By opening the solenoid valve 280a with the solenoid valve 280b closed, dehumidified concentrated oxygen of approximately 60% to 80% in the first oxygen concentration column 272 may be supplied to the lithium-air battery 222. To this end, the controller 190 controls flow paths of the four-way valve 280f so that a downstream of the first oxygen concentration column 272 and a front end of the lithium-air battery 222 are connected. Also, the controller 190 closes the solenoid valve 240b when the solenoid valve 280a is opened, in order to prevent air from flowing into the second adsorption dehumidification column 254. The oxygen supply from the first oxygen concentration column 272 to the lithium-air battery 222 is continuously performed until oxygen partial pressure at a downstream of the first oxygen concentration column 272 drops below 40%.

FIG. 7 is a diagram illustrating operations for <regeneration of a first oxygen concentration column and use of a second oxygen concentration column> of a lithium-air battery-based power supply apparatus according to an embodiment. In FIG. 7, arrows indicate a flow path or flow direction of gas (air or oxygen).

In <discharging: regeneration of the first oxygen concentration column and use of the second oxygen concentration column (308)>, when oxygen partial pressure at a downstream of the first oxygen concentration column 272 drops below 40%, the controller 190 closes the solenoid valves 240a, 260a and 280a, and thus the oxygen supply to the lithium-air battery 222 through the first adsorption dehumidification column 252 and the first oxygen concentration column 272 may be stopped. Also, the controller 190 controls air in the first oxygen concentration column 272 to be discharged to an outside through the vacuum pump 276 by opening the solenoid valve 260c, and thus the regeneration of the first oxygen concentration column 272 may be performed. In addition, by opening the solenoid valves 240b, 260b and 280b, the controller 190 allows dehumidified concentrated oxygen of approximately 60% to 80% in the second oxygen concentration column 274 to be supplied to the lithium-air battery 222. To this end, the controller 190 controls flow paths of the four-way valve 280f so that a downstream of the second oxygen concentration column 274 and a front end of the lithium-air battery 222 are connected. The oxygen supply to the lithium-air battery 222 from the second oxygen concentration column 274 is continuously performed until oxygen partial pressure at a downstream of the second oxygen concentration column 274 drops below 40%.

When the oxygen partial pressure at the downstream of the second oxygen concentration column 274 drops below 40%, the controller 190 repeats the oxygen supply to the lithium-air battery 222 through the completely regenerated first oxygen concentration column 272 as described above, while performing regeneration of the used second oxygen concentration column 274. In other words, in order to continuously supply concentrated oxygen to the lithium-air battery 222, the controller 190 alternately performs use and regeneration (desorption) of the first oxygen concentration column 272 and the second oxygen concentration column 274. For example, the controller 190 enables regeneration of the already used first oxygen concentration column 272 when the completely regenerated second oxygen concentration column 274 is in use. The controller 190 also enables regeneration of the already used second oxygen concentration column 274 when the completely regenerated first oxygen concentration column 272 is in use. Unlike discharging of the lithium-air battery 222 described above, while charging the lithium-air battery 222, concentrated oxygen supply to the lithium-air battery 222 is stopped. Instead, during charging of the lithium-air battery 222, regeneration (desorption) of the first adsorption dehumidification column 252, the second adsorption dehumidification column 254, the first oxygen concentration column 272, and the second oxygen concentration column 274 is performed.

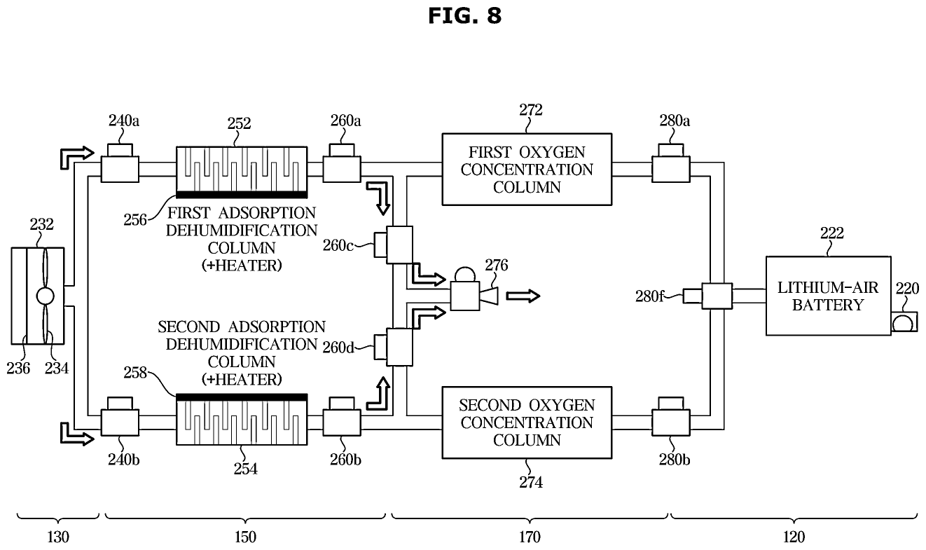

FIGS. 8 and 9 illustrate operations of the lithium-air battery-based power supply apparatus according to an embodiment during charging. Here, FIG. 8 is a diagram illustrating operations of <charging: regeneration of an adsorption dehumidification column> performed while charging a lithium-air battery in a lithium-air battery-based power supply apparatus according to an embodiment. In FIG. 8, arrows indicate a flow path or flow direction of gas (air or oxygen).

For <charging: regeneration of adsorption dehumidification column (310)> performed while charging the lithium-air battery 222, the controller 190 closes the solenoid valves 280a and 280b and thus blocks oxygen supply to the lithium-air battery 222. In the above-described state, by opening all the solenoid valves 240a, 260a, and 260c around the first adsorption dehumidification column 252 and the solenoid valves 240b, 260b, and 260d around the second adsorption dehumidification column 254, the controller 190 controls air, flowing in through the air pump 232, to be discharged to an outside through the vacuum pump 276 after passing through the first adsorption dehumidification column 252 and the second adsorption dehumidification column 254. In addition, by driving the heaters 256 and 258 of the first adsorption dehumidification column 252 and the second adsorption dehumidification column 254, respectively, the controller 190 controls the first adsorption dehumidification column 252 and the second adsorption dehumidification column 254 to be heated for approximately 50 minutes at approximately 120° C. to approximately 150° C.

External power for charging the lithium-air battery 222 may be partially used for heating of the heaters 256 and 258. When regeneration accompanied by heating according to an embodiment is performed for approximately 50 minutes, a saturated moisture rate of the first adsorption dehumidification column 252 and the second adsorption dehumidification column 254 may be reduced from 30 wt % to 10 wt % or less. According to an embodiment, when regeneration accompanied by heating of approximately 100° C. is performed for approximately 120 minutes, a saturated moisture rate of the first adsorption dehumidification column 252 and the second adsorption dehumidification column 254 may be reduced to 5 wt % or less.

For additional regeneration, the controller 190 may perform regeneration on only one of the first adsorption dehumidification column 252 and the second adsorption dehumidification column 254. By the above-described air flow shown in FIG. 8, the first adsorption dehumidification column 252 and the second adsorption dehumidification column 254 may be regenerated while charging the lithium-air battery 222.

FIG. 9 is a diagram illustrating operations of <charging: regeneration of an oxygen concentration column> performed while charging a lithium-air battery in a lithium-air battery-based power supply apparatus according to an embodiment. In FIG. 9, arrows indicate a flow path or flow direction of gas (air or oxygen).

For <charging: regeneration of oxygen concentration column (312)> performed while charging the lithium-air battery 222, the controller 190 opens the solenoid valves 280a, 260c, 280b, and 260d so that air flows from the lithium-air battery 222 to the vacuum pump 276. To this end, the controller 190 closes the solenoid valves 260a and 260b in order to prevent air, flowing to upstream of the first oxygen concentration column 272 and the second oxygen concentration column 274, from flowing into the first adsorption dehumidification column 252 and the second adsorption dehumidification column 254. Also, the controller 190 controls flow paths of the four-way valve 280f provided close to the inlet port of the lithium-air battery 222, so that outside air is introduced and flows to downstream of the first oxygen concentration column 272 and the second oxygen concentration column 274. By the above-described air flow shown in FIG. 9, the first oxygen concentration column 272 and the second oxygen concentration column 274 may be regenerated using outside air, while charging the lithium-air battery 222.

Meanwhile, the above embodiments can be stored in the form of a recording medium storing computer-executable instructions. The instructions may be stored in the form of a program code, and when executed by a processor, the instructions may perform operations of the disclosed embodiments. The recording medium may be implemented as a computer-readable recording medium.

The computer-readable recording medium includes all kinds of recording media in which instructions decoded by a computer are stored in, for example, a read only memory (ROM), random access memory (RAM), magnetic tapes, magnetic disks, flash memories, optical recording medium, and the like.

As should be apparent from the above, according to the embodiments of the disclosure, by miniaturizing a lithium-air battery-based power supply apparatus and increasing the stability and lifespan of the lithium-air battery-based power supply apparatus, the lithium-air battery-based power supply apparatus suitable for small mobility devices and a control method thereof can be provided.

Although embodiments have been described for illustrative purposes, those having ordinary skill in the art should appreciate that various modifications, additions, and substitutions are possible, without departing from the scope and spirit of the disclosure. Therefore, embodiments have not been described for limiting purposes.

What is claimed is:

1. A power supply apparatus, comprising:
an air supply part configured to supply air;
a dehumidification part configured to remove moisture in the air supplied from the air supply part;
an oxygen concentration part including a first oxygen concentration member, a second oxygen concentration member, and a vacuum pump configured to separate and concentrate oxygen from the air from which moisture is removed by the dehumidification part;
a battery part including a lithium-air battery and configured to be supplied with the concentrated oxygen from the oxygen concentration part; and
a controller configured to
in response to discharging the lithium-air battery, generate the concentrated oxygen to be supplied to the lithium-air battery by driving one of the first oxygen concentration member or the second oxygen concentration member, and
regenerate the other of the first oxygen concentration member or the second oxygen concentration member by driving the vacuum pump while the concentrated oxygen is generated.

2. The power supply apparatus of claim 1, the dehumidification part comprising:
a first dehumidifying member;
a second dehumidifying member; and
a heating member configured to heat the first dehumidifying member and the second dehumidifying member,
wherein in response to charging the lithium-air battery, the first dehumidifying member and the second dehumidifying member are heated by using the heating member, and air passing through the first dehumidifying member and the second dehumidifying member is discharged to an outside through the vacuum pump.

3. The power supply apparatus of claim 2, wherein:
the air supply part comprises an air pump configured to draw outside air and supply to a downstream of the air pump;
a discharge port of the air pump is branched into two air flow paths;
one of the two air flow paths is connected to the first dehumidifying member;
the other of the two air flow paths is connected to the second dehumidifying member;
a first valve is provided in the air flow path connecting the discharge port of the air pump and the first dehumidifying member; and
a second valve is provided in the air flow path connecting the discharge port of the air pump and the second dehumidifying member.

4. The power supply apparatus of claim 3, wherein:
a third valve is provided in an air flow path between a discharge port of the first dehumidifying member and the first oxygen concentration member;
a fourth valve is provided in an air flow path between a discharge port of the second dehumidifying member and the second oxygen concentration member;
a fifth valve is provided in an air flow path between an inlet port of the vacuum pump and an inlet port of the first oxygen concentration member which is a downstream of the third valve;
a sixth valve is provided in an air flow path between the inlet port of the vacuum pump and an inlet port of the second oxygen concentration member, which is a downstream of the fourth valve;
a seventh valve is provided in an air flow path between an inlet port of the lithium-air battery and a discharge port of the first oxygen concentration member; and
an eighth valve is provided in an air flow path between the inlet port of the lithium-air battery and a discharge port of the second oxygen concentration member.

5. The power supply apparatus of claim 3, wherein the vacuum pump is connected between an inlet port of the first oxygen concentration member and an inlet port of the second oxygen concentration member.

6. The power supply apparatus of claim 3, further comprising:
a ninth valve provided among a downstream of the first oxygen concentration member, a downstream of the second oxygen concentration member, and an inlet port of the lithium-air battery.

7. The power supply apparatus of claim 6, wherein a flow path of the ninth valve is configured to:
be controlled so that air, discharged from the first oxygen concentration member and flowing through the seventh valve, flows into an inlet port of the lithium-air battery;
be controlled so that air, discharged from the second oxygen concentration member and flowing through the eighth valve, flows into the inlet port of the lithium-air battery; and
be controlled so that air flowed from the outside flows into the first oxygen concentration member and the second oxygen concentration member.

8. The power supply apparatus of claim 7, wherein, in response to charging the lithium-air battery, the controller is configured to control the first oxygen concentration member and the second oxygen concentration member to be regenerated by circulating outside air in the oxygen concentration part through a switch of the flow path of the ninth valve and driving of the vacuum pump.

9. The power supply apparatus of claim 8, wherein, to regenerate the first oxygen concentration member and the second oxygen concentration member, the controller is configured to:
control the flow path of the ninth valve to be switched to supply air to the first oxygen concentration member and the second oxygen concentration member by introducing the outside air; and
control the vacuum pump to be driven to discharge air passing through the first oxygen concentration member and the second oxygen concentration member outside.

10. A control method of a power supply apparatus, the power supply apparatus having
an air supply part provided to supply air,
a dehumidification part configured to remove moisture in the air supplied from the air supply part; an oxygen concentration part including a first oxygen concentration member, a second oxygen concentration member, and a vacuum pump configured to separate and concentrate oxygen from the air from which moisture is removed by the dehumidification part, and
a battery part including a lithium-air battery and configured to be supplied with the concentrated oxygen from the oxygen concentration part,
the control method comprising:
in response to discharging the lithium-air battery, generating the concentrated oxygen to be supplied to the lithium-air battery by driving one of the first oxygen concentration member or the second oxygen concentration member; and
regenerating the other of the first oxygen concentration member or the second oxygen concentration member by driving the vacuum pump while the concentrated oxygen is generated.

11. The control method of claim 10, the dehumidification part comprising:
a first dehumidifying member;
a second dehumidifying member; and
a heating member configured to heat the first dehumidifying member and the second dehumidifying member,
wherein, in response to charging the lithium-air battery, the first dehumidifying member and the second dehumidifying member are heated by using the heating member, and air passing through the first dehumidifying member and the second dehumidifying member is discharged to an outside through the vacuum pump.

12. The control method of claim 11, wherein:
the air supply part comprises an air pump configured to draw outside air and supply to a downstream of the air pump;
a discharge port of the air pump is branched into two air flow paths;
one of the two air flow paths is connected to the first dehumidifying member;
the other of the two air flow paths is connected to the second dehumidifying member;
a first valve is provided in the air flow path connecting the discharge port of the air pump and the first dehumidifying member; and
a second valve is provided in the air flow path connecting the discharge port of the air pump and the second dehumidifying member.

13. The control method of claim 12, wherein:
a third valve is provided in an air flow path between a discharge port of the first dehumidifying member and the first oxygen concentration member;
a fourth valve is provided in an air flow path between a discharge port of the second dehumidifying member and the second oxygen concentration member;
a fifth valve is provided in an air flow path between an inlet port of the vacuum pump and an inlet port of the first oxygen concentration member which is a downstream of the third valve;
a sixth valve is provided in an air flow path between the inlet port of the vacuum pump and an inlet port of the second oxygen concentration member, which is a downstream of the fourth valve;
a seventh valve is provided in an air flow path between an inlet port of the lithium-air battery and a discharge port of the first oxygen concentration member; and
an eighth valve is provided in an air flow path between the inlet port of the lithium-air battery and a discharge port of the second oxygen concentration member.

14. The control method of claim 12, wherein the vacuum pump is connected between an inlet port of the first oxygen concentration member and an inlet port of the second oxygen concentration member.

15. The control method of claim 12, wherein the power supply apparatus further comprises:
a ninth valve provided among a downstream of the first oxygen concentration member, a downstream of the second oxygen concentration member, and an inlet port of the lithium-air battery.

16. The control method of claim 15, wherein a flow path of the ninth valve is configured to:
be controlled so that air, discharged from the first oxygen concentration member and flowing through the seventh valve, flows into an inlet port of the lithium-air battery;
be controlled so that air, discharged from the second oxygen concentration member and flowing through the eighth valve, flows into the inlet port of the lithium-air battery; and
be controlled so that air flowed from the outside flows into the first oxygen concentration member and the second oxygen concentration member.

17. The control method of claim 16, wherein, in response to charging the lithium-air battery, the first oxygen concentration member and the second oxygen concentration member are regenerated by circulating outside air in the oxygen concentration part through a switch of the flow path of the ninth valve and driving of the vacuum pump.

18. The control method of claim 17, wherein
to regenerate the first oxygen concentration member and the second oxygen concentration member, the flow path of the ninth valve is switched to supply air to the first oxygen concentration member and the second oxygen concentration member by introducing the outside air, and
the vacuum pump is driven to discharge air passing through the first oxygen concentration member and the second oxygen concentration member outside.

19. A control method of a power supply apparatus, the power supply apparatus having
an air supply part provided to supply air,
a dehumidification part configured to remove moisture in the air supplied from the air supply part,
an oxygen concentration part including a first oxygen concentration member, a second oxygen concentration member, and a vacuum pump configured to separate and concentrate oxygen from the air from which moisture is removed by the dehumidification part,
a battery part including a lithium-air battery and configured to be supplied with the concentrated oxygen from the oxygen concentration part, and
a four-way valve provided among a downstream of the first oxygen concentration member, a downstream of the second oxygen concentration member, and an inlet port of the lithium-air battery,
the control method comprising:
in response to discharging the lithium-air battery, generating the concentrated oxygen to be supplied to the lithium-air battery by driving one of the first oxygen concentration member or the second oxygen concentration member;
regenerating the other of the first oxygen concentration member or the second oxygen concentration member by driving the vacuum pump while the concentrated oxygen is generated;
in response to charging the lithium-air battery, heating the dehumidification part by using a heating member provided in the dehumidification part, and discharging air passing through the dehumidification part to an outside through the vacuum pump; and
in response to charging the lithium-air battery, regenerating the oxygen concentration part by circulating outside air in the oxygen concentration part through a switch of a flow path of the four-way valve and driving of the vacuum pump.
